(19) United States
(12) Patent Application Publication
(10) Pub. No.: US 2025/0103407 A1
(43) Pub. Date: Mar. 27, 2025

(54) NATURAL LANGUAGE INTERFACE FOR AN APPLICATION PROGRAMMING INTERFACE VIA CASCADING ZERO-SHOT LANGUAGE MODELS

(71) Applicant: Dell Products L.P., Round Rock, TX (US)

(72) Inventors: Iam Palatnik de Sousa, Rio de Janeiro (BR); David Burth Kurka, Campinas (BR); Joel Christner, El Dorado Hills, CA (US); Pedro Chem, Porto Alegre (BR); Vinicius Michel Gottin, Rio de Janeiro (BR); Paulo Abelha Ferreira, Rio de Janeiro (BR)

(21) Appl. No.: 18/476,105

(22) Filed: Sep. 27, 2023

(51) Int. Cl. G06F 9/54; G06F 16/332

(52) U.S. Cl. CPC G06F 9/547; G06F 16/3329

(57) ABSTRACT

Generating a call or request from unstructured input. Natural language, which is unstructured, is received and processed by a language interface engine. The language interface engine executes a series of models in a cascaded manner. One model selects an application programming interface from a set of target application programming interfaces. Another model then selects a particular method of the selected application programming interface. Another model then uses values from the unstructured input as arguments to include in the call. The call is then generated and executed.

### FIELD OF THE INVENTION

Embodiments of the present invention generally relate to a natural language interface in or for a computing system. More particularly, embodiments of the invention relate to accessing or invoking computing applications and resources using unstructured natural language.

### BACKGROUND

Computer applications communicate with each other using structured syntax. When accessing an application programming interface (API), for example, the syntax is typically specified in the specifications of the API. Structuring the syntax of an API enables communications between applications to be performed. When accessing an API, the calling application generates a call that complies with the syntax or structure required by the API. If this structure is not understood or known, the API cannot be effectively accessed or even accessed.

APIs are not generally configured to enable human to application or human to API communications. However, there are a few products that focus on giving human users the ability to make requests using unstructured natural language, which is translated into an API call. Alexa, Siri, and Google Assistant are examples of this process. However, these solutions are limited and often rely on well-defined structures to retrieve the correct commands and API calls in response to keywords uttered by the user. These solutions further lack the ability to generalize.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a language interface engine operating in a computing environment and configured to convert user input into a call;

FIG. 2 discloses aspects of a cascaded language interface for user input;

FIG. 3 discloses aspects of a database that relates APIs and its methods to their descriptions or other metadata;

FIGS. 4A and 4B disclose aspects of constructing a call from unstructured input or of converting unstructured user input into a structured call; and

FIG. 5 discloses aspects of a computing device, system, or entity.

### DETAILED DESCRIPTION OF SOME EXAMPLE EMBODIMENTS

Embodiments of the present invention generally relate to calling application programming interfaces (APIs) based on natural language, which may be spoken or written in some examples. More particularly, at least some embodiments of the invention relate to systems, hardware, software, computer-readable media, and methods for calling an application programming interface that fits or satisfies a user's request or a user's input that is formulated in natural language. Embodiments of the invention further relate to an interface configured to convert a user's unstructured speech (or text) into an API call or to a form that allows an API to be accessed.

In preparing to generate an API call or request from unstructured natural language (e.g., speech or text), embodiments of the invention may process a set or series of services (e.g., API specifications). Upon receiving an instruction from a user and without specific training or hard rules, embodiments of the invention determine or identify an API call that fits or is intended to satisfy the user's request. The API calls or requests are generated and executed and the results of the call or request may be provided to a user or an application.

Many services include documentation (e.g., specification) of their APIs. The documentation may be provided in a standardized format, such as an API digest. The documentation may also include schemas for data structures. The API functions may also include comments, docstrings and other elements in a natural language that may be used by embodiments of the invention. This information may be processed prior to generating API calls from user input.

In one example, multiple natural language processing tasks may be performed in series and/or in parallel. Each of these tasks uses, includes and/or may be embodied as language models. First, for example, zero shot classification may be performed on or using the user's input. Zero shot classification allows a string to be matched to a given arbitrary set of labels, which may be previously unseen. Second, sentence embedding may return a score reflecting the similarity of the semantic content of two sentences. Third, extractive question answering returns elements of a string that correspond to a question or other input that has been provided or generated by a user.

In one example, embodiments of the invention may use trained models to perform these tasks. Further, embodiments of the invention may use models in a cascaded manner to determine or select an API or a set of APIs for a user request.

More specifically, zero shot classification may identify an API that may contain methods to satisfy the user's request. Sentence embedding similarly may identify or determine the API (or the specific method of a previously identified API) that best matches the user's request. Extractive question answering may identify elements in the request to be passed as arguments in the API call. Once the user's request is broken down into parts by this cascaded approach, an API call or request can be formulated.

Embodiments of the invention may use language models to generalize the control and usage of API calls to answer natural language questions and commands. This advantageously does not require users to learn the specific syntax of the API. Further, embodiments of the invention also allow API primitives to be explored by non-expert users and expert users without requiring these users to have prior technical knowledge.

Large language models are examples of neural networks that may be configured to perform natural language processing (NPL) tasks. For example, the GPT-3 architecture, in 2020,is a 175 billion parameter model trained on causal language modelling. This architecture demonstrated that it is possible for a model to be trained in an unsupervised setting, with unannotated text, and learn to generalize a number of NLP tasks. Chat GPT, released in 2022, is a model based on the GPT-e architecture that has undergone reinforcement learning with human feedback (RLHF).

Causal language modelling may be configured to perform text generation. A casaul language model (CLM) may receive some text input and complete the text token by token. The CLM may be configured, simply stated, to predict the most likely next word/token. A CLM may be able to form cohesive and long form texts while maintaining context. In order to use a CLM for generalization to other texts, a very large model (e.g., 175 billion parameters) is required and even in this example, generalization is difficult.

Extractive question answering (EQA) is an NLP task in which a model is asked to retrieve some information from a context and must necessarily use only substrings from that context as a potential response or output. For example, using the context of “Alice and Bod watched a movie”, an EQA model may reply with words from the context (e.g., Alice and Bod) to answer questions such as “Who watched the movie?”.

One benefit of EQA models is that the output or reply is always taken from the context. This eliminates the tendency for hallucinations, which describes a scenario where a model replies with sensible grammar while making up an incorrect or non-factual answer. An EQA model may not provide sensible answers. For example, using a context of “I am coming back on the 17^{th}”, and asked a question of “What is the temperature right now?”, an EQA model will likely answer 17 because that is the only answer that can be extracted from the context.

While CLM models and EQA models often generate text in some form, Zero shot classification (ZSC) models relate to mapping a text input to a set of classes or labels with different probabilities. A ZSC model, however, is distinct from a traditional classification model and may be configured to learn nuances of a language. As a result, ZSC models may be capable of classifying unseen text into previously unseen labels by evaluating the meaning and content withing the text and the labels.

For example, given a context of “Resize the picture dog.jpg to 125×125”, a ZSC model may be asked whether this context represents a call to an image related method, a text related method, or an audio related method. The ZSC would identify that an image related method should be called. ZCS models may be based on similarity calculations between the context and label strings. The similarity may be determined using a cosine similarity between the sentence embeddings of the strings where the embeddings are vectors that encode the semantic content of the strings.

Embodiments of the invention relate to calling one or more language models in a cascaded manner until a specific method or API for the unstructured user request is identified. Once a method is identified, an EQA model may be used to extract arguments to form the request or call to the identified method (or API).

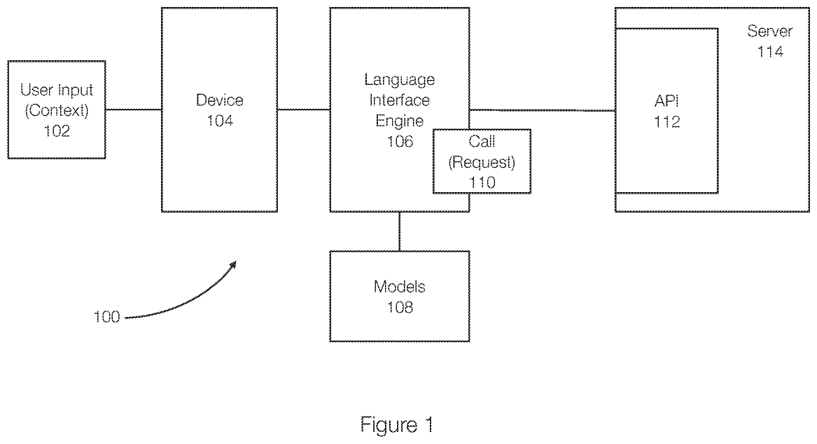

FIG. 1 discloses aspects of a language interface engine configured to convert user input into a call, such as an API call or other structured request. FIG. 1 illustrates a language interface engine 106 operating in a computing environment or system 100. The system 100 may be an on-premise environment, a local area network, a wide area network or the like. The language interface engine 106 may include a server having a processor, memory, and other computing hardware.

In one example, the language interface engine 106 may receive user input 102, which is an example of context, directly or via a device 104. For example, the user input 102 may include text input by a user, speech of a user, speech that may be converted to text, other natural language, or the like. A user may generate the user input 102 on a device 104 such as a smartphone, tablet, laptop, computer, or other device and the user input 102 may be provided to the language interface engine 106. For example, speech received via a microphone may be converted into text and presented to the language interface engine 106.

The language interface engine 106 receives the user input 102 and uses models 108 to generate a call (or API request) 110. The call 110 is input to an API 112 of a server 114 or application. A result of the call, after execution, may be returned to the device 104 for use by an application or the user.

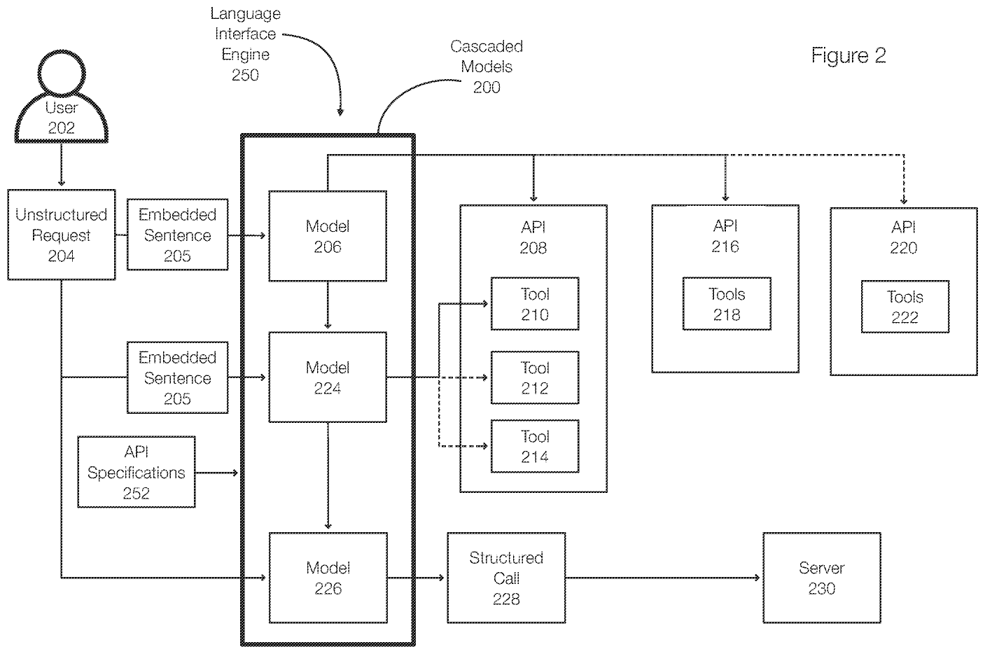

FIG. 2 discloses aspects for a cascaded language interface for user input. FIG. 2 illustrates a user 202 that may provide or generate an unstructured request 204 (e.g., a context). The request is processed by a language interface engine that includes or uses cascaded models 200 to generate a structured call 228 from the unstructured request 204.

FIG. 2 illustrates a plurality of APIs, represented as APIs 208, 216, and 220, that users, systems, or applications can call to interact with a machine or application, its services, or its data (e.g., create, read, update, delete, search). The APIs 208, 216, and 220 may follow a set of standards or specifications (e.g., the OpenAPI standard) where functions, inputs, output, constraints, and conditions withing the API are annotated and described as descriptions or specifications. This may allow developers to write robust integrations using those APIs.

Embodiments of the invention, an example of which includes the language interface engine 250, uses the description, annotations, and other descriptions or information (API specifications 252) associated with APIs as input to the models 206, 224, and/or 226.

The user input or the unstructured request 204, for example, may be viewed as a sentence. In one example, sentence embedding is performed on the unstructured request 204 to generate an embedded sentence 205. Embedding a sentence generally allows a natural language sentence to be represented as a numerical vector. The numerical vector or the embedded sentence 205 encodes semantic information.

The embedded sentence 205 may be provided as input to the model 206, which may be a ZSC model. The model 206 may compare the embedded sentence 205 with the specifications 252 of the APIs 208, 216, 220, which specifications may also be represented as embedded sentences. This allows the model 206, for example using cosine similarity, to identify or select a specific API (API 208 in this example is selected as represented by the solid line). In other words, the descriptions of the API 208 are most similar to the embedded sentence 205. Thus, the model 206 compares the embedded sentence to descriptions of the APIs 208, 216, and 220. This comparison may be performed iteratively. In other words, the embedded sentence representing the user input may be compared to multiple embedded sentences of each API. The most similar description may thus be a cumulative result of multiple comparisons.

FIG. 2 further illustrates that each of the APIs 208, 216, and 220 are associated with various methods, represented by or as tools. The API 208 is associated with tools 210, 212, and 214. The APIs 216 and 220 are similarly associated with, respectively, tools 218 and 222.

In this example, the tools 210, 212, and 214 are also associated with descriptions, annotations, or the like. After the model 206 selects one of the APIs (e.g., the API 208 in this example), the model 224 may select one of the tools 210, 212, and 214 based on the embedded sentence 205. As illustrated by the solid arrow, the tool 210 is selected by the model 224 as a best match, which may be based on a similarity measurement such as cosine similarity.

In this example, once a specific tool (or method) 210 of the API 208 has been selected, a model 226 (e.g., an EQA model) may be used to extract values or data from the unstructured request 204 to include as arguments in the structured call 228. The model 226 may use a description of the parameters of the tool 210 to extract relevant values from the unstructured request 204.

In this example, the language interface engine 250 thus generates a structured call to the selected tool 210 of the selected API 208. If the API 208 is present on or associated with a server (or service) 230, the call to the API 208 may be performed.

In FIG. 2, the language interface engine 250 uses models 206, 224, and 226 in a cascaded manner or as cascaded models 200 to generate a structured call 228 from the unstructured request 204. The models 206, 224, and 226 are cascaded, in one example, as each of these models are executed in succession based on results of the previous model. Thus, the model 224 selects a specific method or tool from an API that was previously selected by the model 206. The model 226 selects values from the unstructured request 204 based on parameters of the tool or method selected by the model 224. The structured call 228 is then generated using these values and then executed or performed.

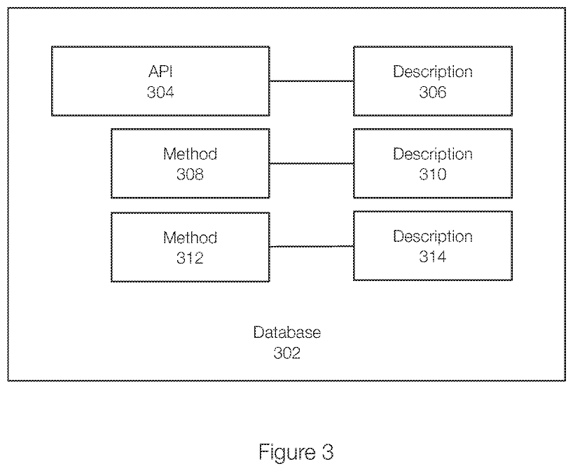

FIG. 3 discloses aspects of a database that relates APIs and their methods to their descriptions or other metadata. Embodiments of the invention may prepare a database or other structure that may be used or accessed by the language interface engine or the models executing therein. In one example, the database 302 relates APIs and their methods to their corresponding descriptions. Thus, the description 306 is associated with the API 304. The methods 308 and 312, which pertain to the API 304, are associated with descriptions 310 and 314 respectively. These descriptions or specifications may be transformed using sentence embedding.

When the models are classifying the unstructured input, the unstructured input may be compared to the descriptions 306, 310, and/or 314 is a cascaded manner (e.g., using sentence embedding). This allows the description that is most similar to the unstructured input to be selected. The database 302 then allows the API to be identified and selected.

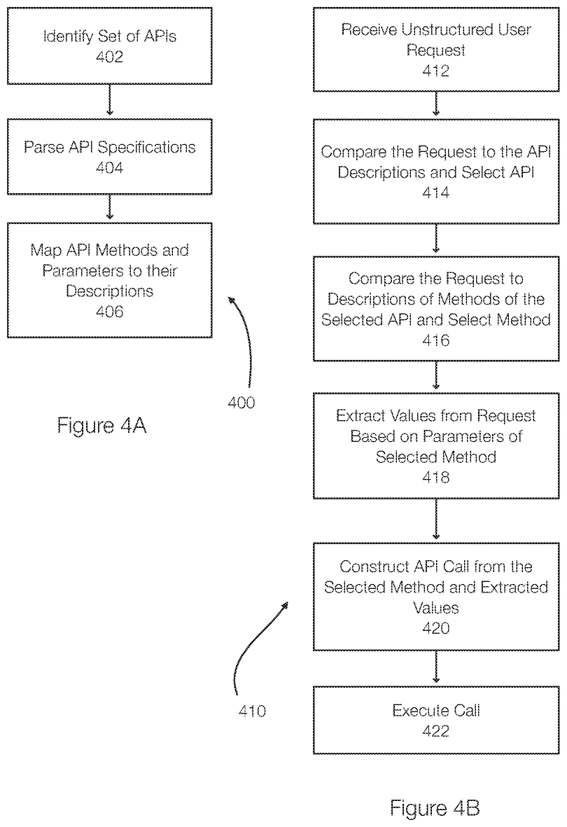

FIGS. 4A and 4B disclose aspects of formulating or constructing a call to an API based on unstructured input. The method 400 in FIG. 4A relates to a preparatory stage of constructing an API call. In the method 400, a target set of APIs are identified 402 or selected. Next, the specifications of the targeted set of APIs are retrieved (e.g., in yaml or json format) and parsed 404 into a structure, such as the database 302, that maps 406 the parameters and methods of an API to the corresponding descriptions of the API. The specifications may be transformed using sentence embedding such that the unstructured input, which may be viewed as a sentence and embedded, can be compared to the specifications.

The method 400 can be performed as necessary. Further, APIs can be added, removed, updated or the like from the set of target APIs. The descriptions can also be amended, changed, removed, updated, or the like. Thus, target set of APIs or other API collection or map can be constructively incremented or otherwise changed collectively or individually.

When constructing a call, a specific method of a specific API may be selected or identified and the descriptions of the APIs generally and of the API's individual methods may be used during the selection process.

The method 410 of FIG. 4B discloses aspects of constructing a call based on unstructured user input. In the method 410, an unstructured request is received 412 from a user. The unstructured request may be text, speech, speech converted to text, or the like. In one example, the unstructured request may be converted to text if not received in that form.

Next, the unstructured request is compared 414 to the descriptions of the APIs (e.g., the description 306) in the database that, in one example, was previously prepared. If necessary, the descriptions can be retrieved as needed. A first model (e.g., a ZSC model) is executed to select an API form the set of target APIs. Generally, the selected API is the API whose description is most similar to the unstructured request or input.

More specifically, the unstructured requests may be embedded into a vector form. The descriptions may also be converted to vector form and the similarity of the unstructured vector can be compared to the description vectors to identify the most similar description vector. The database allows the API corresponding to the most similar description vector to be identified.

Next, a second model, which may also be a ZSC model, is used to compare 416 the request to descriptions of the selected API's methods in a similar manner. Thus, if the API 304 is selected by the first model, the second model may use the descriptions 310 and 314 of the methods 308 and 312 of the API 304 by comparing the descriptions 310 and 314 with the user request. The method that is most similar to the user request is selected. Thus, the first two models, executed in a cascaded or sequential manner, allow a specific method of a specific API to be identified.

Next, a model (e.g., an EQA model) is used to extract 418 values from the request or the context based on the parameters of the method selected by the first and second method. Once the values are extracted from the user request, the values serve as arguments to include in the call. Thus, the API call is constructed 420 based on the selected method and the extracted values.

Once the call is constructed, the call may be executed 422. Results may be returned based on the operation of the API.

In one example, experiments were performed. The ZSC models used in the experiments included BARTY-large (0.4 billion parameters) finetuned on an MNLI dataset. This model performs zero-shot classification through a task called natural language inference, where the model infers whether a given sentence implies on another given sentence.

Another zero shot classification is an Mpnet-base-v2 (0.1 billion parameters). This model generates sentence embeddings, which can then be used for ZSC by comparison of cosine similarities for the request string and the target strings. Given N strings, N cosine similarity values are calculated. The N cosine similarity values can be converted into prediction probabilities using, by way of example, a softmax function.

An example EQA model is ROBERTa-base (0.1 billion parameters), finetuned on a SQUAD2 dataset of question-answer pairs.

In one example, a target set of APIs included the following APIs:
(i) a pet store API;
(ii) a Twitter API;
(iii) a weather API (openweathermap); and
(iv) an AWS S3 API.

Each of these APIs is associated with multiple methods. The experiments tested whether arbitrary natural language commands could be converted into API calls using a cascading approach disclosed herein.

Example requests or contexts included:
(1) Can I have the pet identified as id 1?;
(2) Find all pets with status: available;
(3) Retrieve all tweets from user with id: BarackObama;
(4) What is the forecast for Niteroi; and
(5) Create a copy of the object with key ‘123’ from bucket ‘Test’.

The resulting call generated in accordance with embodiments of the invention included, respectively:
(1) Call: https://petstore.swagger.io:443/v2/pet/% 7Bpetld%7D?petld=1 Parameters: {‘petld’:‘1’};
(2) Call: https://petstore.swagger.io: 443/v2/pet/findByStatus Parameters {‘status’: ‘available’};
(3) Call: https://api.twitter.com/2/users/% 7Bid%7D/tweets?id=BarackObama Parameters: {‘id’: ‘BarackObama’};
(4) Call: https://api.openweathermap.org/data/2.5/forecast Parameters: {‘q’: ‘Niteroi’}; and
(5) Call: https://s3.amazonaws.com//% 7Baws_s3_bucket%7D/%7Baws_s3_object_key%7D?aws_s3_bu cket=Test&aws_s3_object_key=123 Parameters: {‘aws_s3_bucket’: ‘Test’, ‘aws_s3_object_key’: ‘123’}.

For example (1) the first ZSC model selected the pet store API (1), the second ZSC model selected a particular method of the selected API, and the EQA model extracted values from the request to include as arguments or parameters of the call being constructed. The other examples generated calls from unstructured user input in a similar manner. As illustrated, the calls generated by embodiments of the invention are structured API calls that can be executed.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, speech related operations, machine learning model operations, sentence embedding operations, zero shot classification operations, call generation from unstructured input operations, and the like. More generally, the scope of the invention embraces any operating environment in which the disclosed concepts may be useful.

Example cloud computing environments, which may or may not be public, include storage environments that may provide data protection functionality for one or more clients. Another example of a cloud computing environment is one in which processing, data protection, and other services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, storage system components such as databases, storage servers, storage volumes (LUNs), storage disks, and other memory, for example, may likewise take the form of software, physical machines or virtual machines (VMs), though no particular component implementation is required for any embodiment.

As used herein, the term ‘data’ is intended to be broad in scope. Thus, that term embraces, by way of example and not limitation, unstructured data, unstructured speech or text, API specifications, machine learning model input/outputs, or the like.

It is noted that any operation(s) of any of these methods may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving an unstructured request from a user, executing a first model to select an application programming interface (API) from a set of APIs based on the unstructured request and descriptions of the APIs, executing a second model to select a method from methods associated with the selected API based on the unstructured request and descriptions of the methods, executing a third model to extract values from the unstructured request, wherein the extracted values are extracted based on parameters associated with the selected method, and constructing a structured call to the selected API that includes the extracted values as arguments in the structured call.

Embodiment 2. The method of embodiment 1, wherein the first model comprises a first zero shot classification model, the second model comprises a second zero shot classification model, and the third model comprises an extractive question answering model.

Embodiment 3. The method of embodiment 1 and/or 2, further comprising generating a first vector representing semantic information of the unstructured request by performing sentence embedding.

Embodiment 4. The method of embodiment 1, 2, and/or 3, wherein the first model is configured to select the application programming interface by comparing the first vector with vectors of the descriptions of the API using a cosine similarity.

Embodiment 5. The method of embodiment 1, 2, e, and/or 4, wherein the second model is configured to select the method by comparing the first vector with vectors of the descriptions of the methods using a cosine similarity.

Embodiment 6. The method of embodiment 1, 2, 3, 4, and/or 5, wherein the unstructured request comprises text input by a user or speech of a user that is converted to text.

Embodiment 7. The method of embodiment 1, 2, 3, 4, 5, and/or 6, further comprising performing first similarity calculations between the unstructured request and the descriptions of the APIs by the first model to select the application programming interface and performing second similarity calculations between the unstructured request and the descriptions of the methods of the selected API by the second model to select the method.

Embodiment 8. The method of embodiment 1, 2, 3, 4, 5, 6, and/or 7, further comprising executing the structured call by calling the selected API.

Embodiment 9. The method of embodiment 1, 2, 3, 4, 5, 6, 7, and/or 8, further comprising generating a database that maps methods and parameters of the APIs to their descriptions.

Embodiment 10. The method of embodiment 1, 2, 3, 4, 5, 6, 7, 8, and/or 9, further comprising identifying the APIs to include in the set of APIs.

Embodiment 11. The method of embodiment 1, 2, 3, 4, 5, 6, 7, 8, 9, and/or 10, e further comprising updating the set of APIs, wherein updating the set of APIs include adding APIs, removing APIs, amending APIs and/or amending descriptions.

Embodiment 12. A method operable to perform any of the operations, methods, or processes, or any portion of any of these, disclosed herein.

Embodiment 13. A non-transitory storage medium having stored therein instructions that are executable by one or more hardware processors to perform operations comprising the operations of any one or more of embodiments 1-12.

Embodiment 14. A system, comprising hardware and/or software, operable to perform any of the operations, methods, or processes, or any portion of any of these, disclosed herein including the methods or operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, client, service, or the like may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system. A computing entity may also include hardware for connecting to a network such as the Internet.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

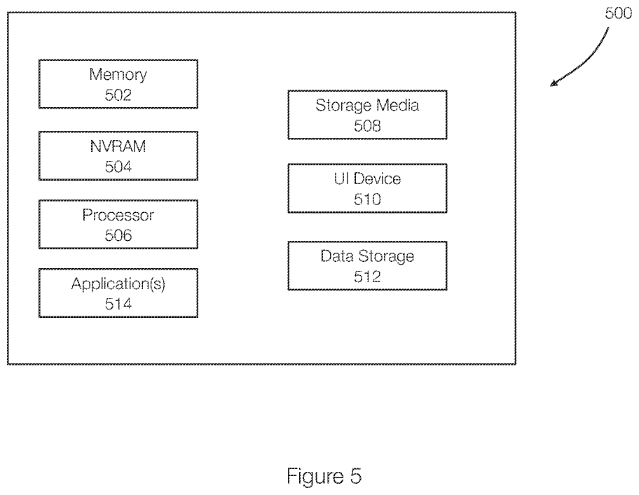

With reference briefly now to FIG. 5, any one or more of the entities disclosed, or implied, by the Figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving an unstructured request from a user;
executing a first model to select an application programming interface (API) from a set of APIs based on the unstructured request and descriptions of the APIs;
executing a second model to select a method from methods associated with the selected API based on the unstructured request and descriptions of the methods;
executing a third model to extract values from the unstructured request, wherein the extracted values are extracted based on parameters associated with the selected method; and
constructing a structured call to the selected API that includes the extracted values as arguments in the structured call.

2. The method of claim 1, wherein the first model comprises a first zero shot classification model, the second model comprises a second zero shot classification model, and the third model comprises an extractive question answering model.

3. The method of claim 1, further comprising generating a first vector representing semantic information of the unstructured request by performing sentence embedding.

4. The method of claim 3, wherein the first model is configured to select the application programming interface by comparing the first vector with vectors of the descriptions of the API using a cosine similarity.

5. The method of claim 3, wherein the second model is configured to select the method by comparing the first vector with vectors of the descriptions of the methods using a cosine similarity.

6. The method of claim 3, wherein the unstructured request comprises text input by a user or speech of a user that is converted to text.

7. The method of claim 1, further comprising performing first similarity calculations between the unstructured request and the descriptions of the APIs by the first model to select the application programming interface and performing second similarity calculations between the unstructured request and the descriptions of the methods of the selected API by the second model to select the method.

8. The method of claim 1, further comprising executing the structured call by calling the selected API.

9. The method of claim 1, further comprising generating a database that maps methods and parameters of the APIs to their descriptions.

10. The method of claim 1, further comprising identifying the APIs to include in the set of APIs.

11. The method of claim 10, further comprising updating the set of APIs, wherein updating the set of APls include adding APls, removing APIs, amending APIs and/or amending descriptions.

12. A non-transitory storage medium having stored therein instructions that are executable by one or more hardware processors to perform operations comprising:
receiving an unstructured request from a user;
executing a first model to select an application programming interface (API) from a set of APIs based on the unstructured request and descriptions of the APIs;
executing a second model to select a method from methods associated with the selected API based on the unstructured request and descriptions of the methods;
executing a third model to extract values from the unstructured request, wherein the extracted values are extracted based on parameters associated with the selected method; and
constructing a structured call to the selected API that includes the extracted values as arguments in the structured call.

13. The non-transitory storage medium of claim 12, wherein the first model comprises a first zero shot classification model, the second model comprises a second zero shot classification model, and the third model comprises an extractive question answering model.

14. The non-transitory storage medium of claim 12, further comprising generating a first vector representing semantic information of the unstructured request by performing sentence embedding.

15. The non-transitory storage medium of claim 14, wherein the first model is configured to select the application programming interface by comparing the first vector with vectors of the descriptions of the API using a cosine similarity. 16 The non-transitory storage medium of claim 14, wherein the second model is configured to select the method by comparing the first vector with vectors of the descriptions of the methods using a cosine similarity.

17. The non-transitory storage medium of claim 14, wherein the unstructured request comprises text input by a user or speech of a user that is converted to text. 18 The non-transitory storage medium of claim 12, further comprising performing first similarity calculations between the unstructured request and the descriptions of the APIs by the first model to select the application programming interface and performing second similarity calculations between the unstructured request and the descriptions of the methods of the selected API by the second model to select the method.

19. The non-transitory storage medium of claim 12, further comprising executing the structured call by calling the selected API.

20. The non-transitory storage medium of claim 12, further comprising one or more of:
generating a database that maps methods and parameters of the APIs to their descriptions;
identifying the APIs to include in the set of APIs; and/or updating the set of APIs, wherein updating the set of APIs include adding APIs, removing APIs, amending APIs and/or amending descriptions.
